(19) United States
(12) Patent Application Publication
(10) Pub. No.: US 2011/0068091 A1
(43) Pub. Date: Mar. 24, 2011

(54) Ceramic Heater and Glow Plug

(75) Inventor: Norimitsu Hiura, Kirishima-shi (JP)

(73) Assignee: KYOCERA CORPORATION, Kyoto-shi, Kyoto (JP)

(21) Appl. No.: 12/864,864

(22) PCT Filed: Jan. 29, 2009
(86) PCT No.: PCT/JP2009/051484

§ 371 Date: Dec. 2, 2010

(30) Foreign Application Priority Data
Jan. 29, 2008 (JP) 2008-018207

(51) Int. Cl. F23Q 7/22; H05B 3/10; H05B 3/02

(52) U.S. Cl. 219/270; 219/553; 219/544

(57) ABSTRACT

The ceramic heater used in a glow plug, which is used under harsh conditions, is required to be improved in durability. The ceramic heater 11 comprising: a heating resistor 13; a first lead member 15 and a second lead member 17; a first electrode lead-out member 19 and a second electrode lead-out member 21 electrically connected, respectively, to the ends of the first and second lead member opposite to the respective ends thereof that are electrically connected to the heating resistor 13; a ceramic base 23 in which the heating resistor 13, the first lead member 15, the second lead member 17, the first electrode lead-out member 19 and the second electrode lead-out member 21 are embedded; and a first electrode 25 and a second electrode 27 that are formed on the surface of the ceramic base, wherein in the first electrode lead-out member 19 the area S1 of the connection part with the first electrode is larger than the area S2 of the connection part with the first lead member.

### FIELD OF THE INVENTION

The present invention relates to a ceramic heater used in such applications as, for example, ignition or flame detection heater for onboard heating apparatus of combustion type, ignition heater for kerosene-burning fan heater and other combustion apparatuses, heater for glow plug, heater for various sensors such as oxygen sensor, and heater for measuring instrument.

### BACKGROUND ART

Among ceramic heaters used in such applications as glow plug of automobile engine, there is known a ceramic heater comprising a ceramic base and a ceramic heating element that is embedded in the ceramic base and generates heat through electrical resistance when supplied with power through electrodes connected to both ends thereof. In the ceramic heater having such a constitution, the ceramic heating element comprises a U-shaped turn-over section extending from a base on one side and turns over at the distal end to toward a base on the other side, and two straight lead members extending in the same direction from the bases of the turn-over section (see, for example, Patent Documents 1 and 2).

However, in order to ensure the strength of the ceramic heater, the lead member of the ceramic heating element is made thinner than in the distal end portion, and an electrode lead-out member that connects the lead member and the electrode formed on the surface of the ceramic base is also made thinner because the lead member is thin. As a result, while the ceramic heater used in a glow plug, for example, is required to have more quick heating capability and durability at higher temperatures in recent years, there has been such a problem that the electrode lead-out member that connects the lead member and the electrode formed on the surface is more likely to deteriorate than the ceramic heating element, when used under such harsh conditions over a long period of time. This reason is supposedly because the electrode lead-out member is thin and therefore has higher electric resistance, while contact resistance between the electrode lead-out member and the lead member and contact resistance between the electrode lead-out member and the electrode formed on the surface become higher, thus resulting in more tendency to generate heat.

In order to solve the problem described above, for example, Patent Document 3 discloses a glow plug wherein the electrode lead-out member is formed in a direction perpendicular to the ceramic heating element and an area of a cross section of the electrode lead-out member is made larger than an area of a cross section of the ceramic heating element.
Patent Document 1: Japanese Unexamined Patent Publication (Kokai) No. 9-184626
Patent Document 2: Japanese Unexamined Patent Publication (Kokai) No. 9-184622
Patent Document 3: Japanese Unexamined Patent Publication (Kokai) No. 2006-49279

### DISCLOSURE OF THE INVENTION

### Problems to be Solved by the Invention

When the electrode lead-out member is formed in a direction perpendicular to the ceramic heating element and the area of the cross section of the electrode lead-out member is made larger than the area of the cross section of the ceramic heating element as described in Patent Document 3, increasing the cross section of the electrode lead-out member leads to lower electrical resistance thereof, thereby decreasing the contact resistance between the electrode lead-out member and the lead member and the contact resistance between the electrode lead-out member and the electrode formed on the surface. However, since the electrode lead-out member having lower strength than ceramics is increased in volume, the strength of the ceramic heater decreases. Also the use of an expensive noble metal in the electrode lead-out member leads to a high production cost of the ceramic heater.

The present invention has been made to solve the problems described above and an object thereof is to provide a ceramic heater having higher durability at a low cost.

### Means for Solving the Problems

A ceramic heater of the present invention comprises a heating resistor, a first lead member and a second lead member electrically connected to both ends of the heating resistor, respectively, a first electrode lead-out member and a second electrode lead-out member electrically connected to an end of the first lead member and an end of the second lead member, respectively, the end of the first lead member and the end of the second lead member being opposite to the respective ends thereof that are electrically connected to the heating resistor, a ceramic base in which the heating resistor, the first lead member, the second lead member, the first electrode lead-out member and the second electrode lead-out member are embedded, and a first electrode and a second electrode that are formed on the surface of the ceramic base, and are electrically connected to the first electrode lead-out member and the second electrode lead-out member, respectively, wherein an area of a connection part between the first electrode lead-out member and the first electrode is larger than an area of a connection part between the first electrode lead-out member and the first lead member.

In the ceramic heater of the present invention with the constitution described above, the first electrode lead-out member comprises an area increasing section in which an area of a cross section perpendicular to the direction increases from a side of the first lead member toward a side of the first electrode.

In the ceramic heater of the present invention with the constitution described above, the first electrode lead-out member comprises an area increasing section in which an area of a cross section perpendicular to the direction increases from a side of the first lead member toward a side of the first electrode.

In the ceramic heater of the present invention with the constitution described above, the first electrode lead-out member comprises an area decreasing section in which an area of a cross section perpendicular to the direction decreases from the side of the first lead member toward the side of the first electrode, or an area constant section in which an area of a cross section perpendicular to the direction remains constant in the direction.

### EFFECTS OF THE INVENTION

According to the ceramic heater of the present invention, an area of a connection part between the first electrode lead-out member and the first electrode is larger than an area of a connection part between the first electrode lead-out member and the first lead member, that results in lower electrical resistance of the electrode lead-out member than in a case where an area of a cross section remains constant from the connection part thereof with the first lead member up to the connection part thereof with the first electrode, and therefore heat can be suppressed from being generated in the first electrode lead-out member and in the first electrode during operation. Increasing the area of the connection part between the first electrode lead-out member and the first electrode enables it to decrease the contact resistance between the first electrode lead-out member and the first electrode, thereby further suppressing the heat generation. As a result, durability of the first electrode lead-out member and the first electrode can be improved.

According to the ceramic heater of the present invention with the constitution described above, when the first electrode lead-out member comprises a cross section which is perpendicular to a direction from a side of the first lead member toward a side of the first electrode and is round or oval, since the profile of the cross section is formed from smooth curve, localized heat generation can be suppressed.

Furthermore, according to the ceramic heater of the present invention with the constitution described above, when the first electrode lead-out member comprises an area increasing section in which an area of a cross section perpendicular to the direction increases from the side of the first lead member toward the side of the first electrode, since abrupt change in electrical resistance does not occur in the first electrode lead-out member, the risk of abnormal heating can be decreased. Also because volume of the first electrode lead-out member increases continuously from a side of the first lead member to a side of the first electrode, cracks can be effectively suppressed from occurring even when the volume changes such as shrinkage in degreasing step or firing step during the production. As a result, reliability and durability of the ceramic heater as a final product can be improved.

Furthermore, according to the ceramic heater of the present invention with the constitution described above, when the first electrode lead-out member comprises an area constant section in which an area of a cross section perpendicular to the direction remains constant from the side of the first lead member toward the side of the first electrode, since the area of connection part of the first electrode lead-out member with the first electrode can be secured so as to keep the contact resistance low and volume of the first electrode lead-out member can be suppressed from increasing in the constant area section, quantity of expensive noble metal used can be decreased and the production cost can be decreased.

Moreover, when the first electrode lead-out member comprises an area decreasing section in which an area of a cross section perpendicular to the direction decreases from the side of the first lead member toward the side of the first electrode, the area of the connection part with the first electrode of the first electrode lead-out member can be secured to keep the contact resistance low and the area of the connection part with the first lead member can be secured to keep the contact resistance low, thus making it possible to suppress heat generation in the first electrode lead-out member. Furthermore, since volume can be suppressed from increasing in the middle portion of the first electrode lead-out member, quantity of expensive noble metal used can be decreased and the production cost can be decreased.

### BEST MODE FOR CARRYING OUT THE INVENTION

The ceramic heater according to one embodiment of the present invention will be described in detail below with reference to the accompanying drawings. FIG. 1 is a longitudinal sectional view showing a ceramic heater according to one embodiment of the present invention, and FIG. 2 is an enlarged plan view of the vicinity of the first electrode of the ceramic heater shown in FIG. 1 as viewed in the direction of an arrow V. In the following drawings including these drawings, hatchings to be depicted in cross sections of the ceramic base will be omitted. As shown in FIG. 1, the ceramic heater 11 has a heating resistor 13, a first lead member 15 and a second lead member 17 electrically connected to both ends of the heating resistor 13, a first electrode lead-out member 19 and a second electrode lead-out member 21 electrically connected, respectively, to the ends of the first lead member 15 and the second lead member 17 opposite to the ends thereof that are electrically connected to the heating resistor 13, and a bar-shaped ceramic base 23 in which the heating resistor 13, the first lead member 15, the second lead member 17, the first electrode lead-out member 19 and the second electrode lead-out member 21 are embedded. The heating resistor 13 is embedded on the first end 12 side of the ceramic base 23.

The ceramic base 23 comprises a first electrode 25 and a second electrode 27 electrically connected, respectively, to the first electrode lead-out member 19 and the second electrode lead-out member 21, formed on the surface thereof. The first electrode 25 is formed on a side face of the ceramic base 23.

As shown in FIG. 3 which is an enlarged sectional view of the vicinity of the first electrode lead-out member 19 shown in FIG. 1, FIG. 4 which is an enlarged sectional view of another embodiment and FIG. 5 which is an enlarged sectional view of still another embodiment, the first electrode lead-out members 19, 31, 32 have area S1 of the connection part with the first electrode 25 larger than the area S2 of the connection part with the first lead member 15. This is an important feature of the present invention.

According to the present invention, since the area S1 of the connection part between the first electrode lead-out member 19 and the first electrode 25 is larger than the area S2 of the connection part between the first electrode lead-out member 19 and the first lead member 15, electrical resistance of the electrode lead-out member can be made lower than that of a case where an area of a cross section remains constant from the connection part thereof with the first lead member 15 up to the connection part with the first electrode 25, and therefore heat can be suppressed from being generated in the first electrode lead-out member 19 and the first electrode 25 during operation. Increasing the area of the connection part between the first electrode lead-out member 19 and the first electrode 25 enables it to decrease the contact resistance between the first electrode lead-out member 25 and the first electrode 25, thus further suppressing the heat generation. As a result, durability of the first electrode lead-out member 19 and the first electrode 25 can be improved.

Particularly, as the area S1 of a portion of the first electrode lead-out member 19 near the surface of the ceramic base 23 is increased, this improves heat dissipation from the first electrode lead-out member 19 through the first electrode 25 and suppresses the temperature from rising in the portion near the surface of the ceramic base 23. As a result, the first electrode lead-out member 19 can be suppressed from deteriorating, and cracks can be suppressed from occurring in the ceramic base 23 due to heat generated in the first electrode lead-out member 19. Particularly it is made possible to effectively suppress cracks from occurring in the surface of the ceramic base 23.

It is preferable that a ratio S1/S2 of the area S1 of the connection part with the first electrode 25 to the area S2 of the connection part with the first lead member 15 in the first electrode lead-out member 19 is 1.1 or more, more preferably 1.2 or more, and still more preferably 1.5 or more, in order to make the electrical resistance of the first electrode lead-out member 19 lower than that of a case in which an area of a cross section remains constant from the connection part thereof with the first lead member 15 up to the connection part thereof with the first electrode 25. There is no particular limitation on the upper limit to the ratio S1/S2, which may be appropriately determined with consideration given to such factors as dimensions and arrangement of the ceramic base 23 and other members.

It is preferable that the first electrode lead-out member 19 comprises a cross section which is perpendicular to a direction from a side of the first lead member 15 toward a side of the first electrode 25 and is round or oval. The cross section having a round or oval shape results in the profile of the cross section having a smooth curve, that enables it to suppress localized heat generation.

The first electrode lead-out member 19 described above is preferably formed, for example, by the injection molding method as shown in a production method described hereinafter. When the first electrode lead-out member 19 is formed by the injection molding method, the first electrode lead-out member 19 can be formed with round or oval cross section more easily than in the case of using the printing method. When the first electrode lead-out member 19 is formed by printing method, it is necessary to carry out the printing operation a plurality of times since it is difficult to ensure sufficient thickness by a single printing operation. This takes time since it is necessary to correctly align the position every time the printing operation is carried out while positional displacement is likely to occur between the printing operations, thus making it difficult to form smooth round or oval cross section. To the contrary, when the first electrode lead-out member 19 is formed by the injection molding method, the forming method is completed by a single molding operation using a die, so that the first electrode lead-out member 19 can be formed with round or oval cross section easily with high accuracy.

In the example shown in FIG. 3, the first electrode lead-out member 19 comprises an area increasing section in which an area of a cross section perpendicular to the direction increases from the side of the first lead member 15 toward the side of the first electrode 25. Thus the first electrode lead-out member 19 in this example has a conical shape truncated at the top. Such a structure enables it to make the electrical resistance of the first electrode lead-out member 19 lower than that of a case in which an area of a cross section remains constant from the connection part thereof with the first lead member 15 up to the connection part thereof with the first electrode 25, thereby to suppress heat generation in the first electrode lead-out member 19 and in the first electrode 25 during operation. Also increasing the area of the connection part of the first electrode lead-out member 19 with the first lead member 15 decreases the contact resistance between the first electrode lead-out member 19 and the first lead member 15, so as to further suppress the heat generation. As a result, durability of the first electrode lead-out member 19 and the first electrode 25 can be improved.

When the first electrode lead-out member 19 comprises an area increasing section in which an area of a cross section perpendicular to the direction increases from the side of the first lead member toward the side of the first electrode as shown in FIG. 3, since abrupt change in electrical resistance does not occur in the first electrode lead-out member 19, the risk of abnormal heating can be decreased. Also because volume of the first electrode lead-out member 19 increases or decreases continuously from a side of the first lead member 15 to a side of the first electrode 25 in the area increasing section, cracks can be effectively suppressed from occurring even when shrinkage occurs in degreasing step or firing step during the production. As a result, reliability and durability of the ceramic heater as a final product can be improved. Furthermore, since defects such as crack can be suppressed from occurring in the green compact, yield of production can be improved.

In the example shown in FIG. 4, the first electrode lead-out member 31 comprises the constant area section 31a in which an area of a cross section remains constant in the direction of arrow D1 from a side of the first lead member 15 toward a side of the first electrode 25 and the area increasing section 31b in which an area of a cross section increases in the direction of arrow D1.

When the first electrode lead-out member 31 comprises an area constant section 31a in which an area of a cross section perpendicular to the direction remains constant from the side of the first lead member 15 toward the side of the first electrode 25 as described above, since the area of the connection part of the first electrode lead-out member 31 with the first electrode 25 can be made larger to keep the contact resistance low and volume of the first electrode lead-out member 31 can be suppressed from increasing in the constant area section 31a, quantity of expensive noble metal used in the first electrode lead-out member 31 can be decreased and the production cost can be decreased.

When the area increasing section 31b and the constant area section 31a are combined as described above, there is a portion where the direction in which the side face of the first electrode lead-out member 31 inclines changes in the border between these sections. As a result, when the ceramic heater 11 is molded and fired, or when an external stress is applied, the portion where the direction in which the side face of the first electrode lead-out member 31 inclines changes in the ceramic base 23 serves as a hook, to prevent the first electrode lead-out member 31 from moving and position shifting in the ceramic base 23.

In the example shown in FIG. 5, the first electrode lead-out member 32 has the area decreasing section 32a in which an area of a cross section perpendicular to the direction of arrow D1 decreases as it goes toward the direction of arrow D1, the constant area section 32b in which an area of a cross section remains constant in the direction of arrow D1 and the area increasing section 32c in which an area of a cross section increases as it goes toward the direction of arrow D1. When the area decreasing section 32a, the constant area section 32b and the area increasing section 32c are combined, or the area decreasing section 32a and the area increasing section 32c are combined, in any case, there are one or more portions where the direction in which the side face of the conductor inclines changes in the border of the conductor. As a result, when the ceramic heater 11 is molded and fired, or when an external stress is applied to the ceramic heater 11, the portion where the direction in which the side face of the first electrode lead-out member 32 inclines changes in the ceramic base 23 serves as a hook, to prevent the first electrode lead-out member 32 from moving and position shifting in the ceramic base 23.

Such a constitution makes it possible to ensure the area of the connection part of the first electrode lead-out member 32 with the first electrode 25 and the area of the connection part between the first electrode lead-out member 32 and the first lead member 15 can be respectively maintained in the area increasing section 32c and in the area decreasing section 32a, so as to keep the contact resistance in the connection part low and volume of the first electrode lead-out member 32 can be suppressed from increasing in the constant area section 32b in which an area of a cross section does not change, and therefore quantity of expensive noble metal used in the first electrode lead-out member 32 can be decreased and the production cost can be decreased.

As shown in FIG. 1, the second electrode 27 is formed to cover an end face 14a and a lateral face 14b of a second end portion 14 of the ceramic base 23. As shown in FIG. 1, FIG. 6 that is an enlarged sectional view of the vicinity of the second electrode lead-out member 27 of the ceramic heater shown in FIG. 1, FIG. 7 that is a front view of the ceramic heater shown in FIG. 1 as viewed in the direction H indicated with arrow in FIG. 1, and FIG. 8 that is a sectional view taken along lines A-A in FIG. 1, the second electrode lead-out member 21 has an area of a connection part with the second electrode 27 larger than an area of a connection part with the second lead member 17, and therefore enables it to make the electrical resistance of the second electrode lead-out member 21 lower than that of a case in which an area of a cross section remains constant from the connection part thereof with the second lead member 17 up to the connection part thereof with the second electrode 27, thereby to suppress heat generation in the second electrode lead-out member 21 during operation, so that the second electrode lead-out member 21 can be suppressed from deteriorating.

It is preferable that a ratio S3/S4 of the area S3 of the connection part with the second electrode 27 to the area S4 of the connection part with the second lead member 17 in the second electrode lead-out member 21 is 1.3 or more, and more preferably 3.7 or more, in order to make the electrical resistance of the second electrode lead-out member 21 lower than that of a case in which the area remains constant from the connection part thereof with the second lead member 17 up to the connection part thereof with the second electrode 27. There is no particular limitation on the upper limit to the ratio S3/S4, which may be appropriately determined with consideration given to such factors as dimensions and arrangement of the ceramic base 23 and other members.

It is preferable that the second electrode lead-out member 21 has round or oval area of a cross section perpendicular to the direction from the second lead member 17 toward the second electrode 27. The cross section having round or oval shape enables it to suppress localized heat generation. The cross section having round or oval shape enables it to suppress heat from being generated locally. The cross section having round or oval shape also decreases heat generation in the connection part thereof with the second electrode 27 and in the connection part thereof with the second lead 17.

As shown in FIG. 6, the second electrode lead-out member 21 has the area increasing section 21a in which an area of a cross section perpendicular to the direction of arrow D2 increases in the direction of arrow D2 from the second lead member 17 toward the second electrode 27. Therefore, since abrupt change in electrical resistance does not occur in the second electrode lead-out member 21, heat generation by the second electrode lead-out member 21 can be further suppressed. Also because volume of the second electrode lead-out member 21 increases or decreases continuously between the second lead member 17 and the second electrode 27, cracks can be effectively suppressed from occurring in the ceramic base 23 even when shrinkage occurs in degreasing step or firing step during the production of the ceramic heater. As a result, reliability and durability of the ceramic heater as a final product can be improved. Furthermore, since defects such as crack can be suppressed from occurring in the green compact of the ceramic base 23, yield of production can be improved.

In the example shown in FIG. 6, the second electrode lead-out member 21 has the area decreasing section 21b, in which an area of a cross section decreases as it goes toward the direction of arrow D2, provided at the position located in the direction of arrow D2 from the area increasing section 21a. Regarding the second end portion 14, as it goes toward the end face 14a of the second end portion 14, the diameter thereof becomes smaller (hereafter referred to as a small-diameter section 14). The area increasing section 21a and the area decreasing section 21b of the second electrode lead-out member 21 are embedded in the small-diameter section 14, and the area decreasing section 21b is disposed along the small-diameter section 14. The second electrode lead-out member 21 is constituted by disposing the area increasing section 21a and the area decreasing section 21b in this order from the second lead member 17 side toward the second electrode 27. When the area increasing section 21a in which an area of cross section increases as it goes toward the direction of arrow D2 and the area decreasing section 21b in which the area of the cross section decreases are provided in this way, strength of the product can be enhanced in the vicinity of the second electrode lead-out member 21 by decreasing the volume of the electrode lead-out material that has low hardness while maintaining an area of a cross section enough to flow electric current, thus enabling it to provide a product of higher reliability.

As shown in FIG. 9 which is an enlarged sectional view of the vicinity of the second electrode lead-out member 33 of the ceramic heater 11 of another embodiment, the second electrode lead-out member 33 may also be constituted from the area increasing section 33a in which a cross sectional perpendicular to this direction area increases as it goes from the second lead member 17 toward the second end portion 14, the constant area section 33b of which an area of a cross section remains constant and the area decreasing section 33c of which an area of a cross section decreases. Such a constitution enables it to decrease the volume of the electrode lead-out material that has low hardness, thereby further increasing the strength of the product in the vicinity of the second electrode lead-out member 21.

The second electrode 27 is formed on the end face 14a of the second end portion 14 and a lateral face 14b of the second end portion 14 connected to the end face 14a. As shown in FIG. 10 which is a side view depicting a state of a metal fitting section 35 fitted onto the second end portion 14 of the ceramic heater 11 shown in FIG. 1, the metal fitting section 35 having a recess is fitted onto the small-diameter section (the second end portion) 14 so as to cover the second electrode 27. This configuration enables it to suppress the second electrode 27 from being oxidized. Particularly as shown in FIG. 11 which is a side view depicting another embodiment of the connection part structure between the second end portion 14 and the metal fitting section 35, it is preferable that the metal fitting section 35 covers the entire surface of the second electrode 27. This enables it to further improve the effect of suppressing the second electrode 27 from being oxidized, and also increase the contact area between the metal fitting section 35 and the second electrode 27, thereby decreasing the electrical resistance of this portion and further suppressing heat generation.

It is possible to use, as a heating resistor 13, materials containing carbides, nitrides and silicades of W, Mo and Ti as main component. Of these materials, WC is excellent as the material of the heating resistor 13 in view of thermal expansion coefficient, heat resistance and resistivity. The heating resistor 13 contains an inorganic electric conductor WC as the main component and, for example, when the ceramic base 23 is produced using silicon nitride ceramics as described hereinafter, it is preferred to adjust the proportion of silicon nitride to be added in the heating resistor 13 to 20% by mass or more. Among silicon nitride ceramics, since a conductor component, that would be turned into the heating resistor 13, has a larger thermal expansion coefficient than that of silicon nitride, it is in a state where tensile stress is applied. To the contrary, the addition of silicon nitride itself, as a common material, to the heating resistor 13 brings the thermal expansion coefficient close to that of silicon nitride as the base material, thus making it possible to release stress due to difference in thermal expansion of the ceramic heater 11 upon heating and cooling.

When the additive amount of silicon nitride is 40% by mass or less, it is possible to satisfactorily stabilize electrical resistance. The additive amount of silicon nitride is preferably adjusted within a range from 25 to 35% by mass. It is also possible to add, as an additive to the heating resistor 13, 4 to 12% by mass of boron nitride instead of silicon nitride.

It is possible to use, as the materials of the first lead member 15 and the second lead member 17, same materials as those of the heating resistor 13. Of these materials, WC is excellent as the material of lead members 15, 17 in view of thermal expansion coefficient, heat resistance and resistivity. The first lead member 15 and the second lead member 17 contain an inorganic electric conductor WC as the main component. Similarly to the heating resistor 13 described above, when a ceramic base 23 is produced using silicon nitride ceramics, it is preferred to adjust the proportion of silicon nitride to be added in the first lead member 15 and the second lead member 17 to 15% by mass or more. As the additive amount of silicon nitride increases, it is possible to bring the thermal expansion coefficient of the first lead member 15 and the second lead member 17 close to that of silicon nitride as the base material. When the additive amount of silicon nitride is 40% by mass or less, since electrical resistance becomes stable, the additive amount of silicon nitride is preferably adjusted to 40% by mass or less. More preferably, the additive amount of the silicon nitride is adjusted within a range from 20 to 35% by mass.

It is possible to use, as the material of the ceramic base 23, ceramics having insulating properties, such as oxide ceramics, nitrides ceramics or carbides ceramics. It is particularly preferred to use silicon nitride ceramics. The reason why silicon nitride ceramics are particularly preferred is that silicon nitride as the main component is excellent in view of high strength, high toughness, high insulating properties and heat resistance. The silicon nitride ceramics can be obtained, for example, by mixing silicon nitride as the main component with sintering aids, for example, 3 to 12% by mass of rare earth element oxides such as Y₂O₃, Yb₂O₃ and Er₂O₃, 0.5 to 3% by mass of Al₂O₃, and 1.5 to 5% by mass of SiO₂ in terms of SiO₂ contained in the resultant sintered body, and forming the mixture into s predetermined shape, followed by firing through hot pressing at 1,650 to 1,780° C.

When silicon nitride is used as the material of the ceramic base 23, it is preferred that MoSiO₂ or WSi₂ are dispersed. The reason is that durability of the ceramic heater 11 can be improved by bringing the thermal expansion coefficient of the base material closer to that of the heating resistor 13.

A method of producing the ceramic heater 11 of the above-mentioned embodiment will be described below. The ceramic heater 11 of the present embodiment can be molded by an injection molding method using a die fabricated so as to form the first electrode lead-out member 19 having the area of the connection part with the first electrode 25 larger than the area of the connection part with the first lead member 15.

First, a mixed material for conductor containing an electrically conductive ceramic powder and a binder and a mixed material for a substrate containing an insulating ceramics and a binder are prepared. The mixed material for conductor is used to form a green compact for heating resistor by an injection molding method. While holding the green compact for heating resistor thus obtained in an injection molding die, the die is filled with the mixed material for conductor, thereby to mold the green compact for lead member. This results in a green compact for conductor comprising the green compact for heating resistor and the green compact for lead member held within the die.

Using the green compact for conductor held in the die, a part of the die is replaced with a component used to form the ceramic base, and the die is filled with the mixed material for substrate. This results in a green compact of element comprising the green compact for conductor covered by the green compact for ceramic base. The green compact of element is then fired so as to make the ceramic heater. The firing operation is preferably carried out in a non-oxidizing atmosphere.

### <Glow Plug>

The glow plug according to one embodiment of the present invention will be described below. As shown in FIG. 12 which is a sectional view of a glow plug according to one embodiment of the present invention, the glow plug 51 comprises the ceramic heater 11 inserted into a tubular metal fitting 53. The tubular metal fitting 53 is used as a cathode, and is electrically connected to the first electrode 25 that is exposed on the side face of the ceramic heater 11. Disposed in the tubular metal fitting 53 is an anode metal fitting 55 that is electrically connected to the second electrode 27. When electric current is supplied to flow through the tubular metal fitting 53 and the anode metal fitting 55, the glow plug of the present embodiment functions as a heat source, for example, to start an engine.

### EXAMPLES

The ceramic heater according to one embodiment of the present invention was made as follows. First, a material consisting of WC and silicon nitride as the main components was injected into a die thereby to mold the green compact for heating resistor. While holding the green compact for a heating resistor thus obtained in an injection molding die, the die was filled with the green compact for a lead member, thereby to integrate the green compact for a heating resistor and the green compact for a lead member within the die and obtain the green compact for conductor. Specimens Nos. 1 through 16 shown in Table 1 and Table 2 are samples that were molded by using dies having electrode lead-out members of various shapes. The electrode lead-out member of each specimen was formed so that the cross section perpendicular to the direction from the lead member to the electrode would have oval shape. The yield of molding for each specimen was evaluated and the shapes thereof were compared.

Using the green compact for conductor held in the injection molding die, a ceramic material, prepared by adding a sintering aid composed of an oxide of ytterbium (Yb) and MoSi₂ used to control the thermal expansion coefficient to a value near that of the heating resistor and the lead member to silicon nitride (Si₃N₄), was molded by an injection molding method. Thus, a structure comprising the green compact for conductor embedded in the green compact for a ceramic base was obtained.

The green compact thus obtained was put into a tubular carbon die and was fired by a hot press method at a temperature in a range from 1,650° C. to 1,780° C. under a pressure from 10 to 50 MPa in a reducing atmosphere. Metal fittings were brazed onto the first electrode lead-out member and the second electrode lead-out member exposed on the surface of the sintered body thus obtained, thereby making the ceramic heater. Using a K thermocouple attached to these metal fittings, temperature of the electrode lead-out member was measured in the state of saturated energization. Design temperature of the electrode is usually considered to be desirably 300° C. or lower, and therefore the temperature not higher than this level is thought to be advantageous in terms of durability of the electrode.

The ceramic heaters made as described above were subjected to a thermal cycle test. One cycle was set to consist of 5 minutes of supplying current to the ceramic heater with voltage applied so that the electrode would be heated to 400° C. and 2 minutes of shutting off the current, and ten thousand thermal cycles were repeated. Electrical resistance of the ceramic heater was measured before and after energization, and specimen that showed 5% or more change in electrical resistance was evaluated as NG. Cracks generated in the electrode or the electrode lead-out member were observed in the specimens evaluated as NG. The results are shown in Table 1 and Table 2.

TABLE 1

| | First electrode lead-out member | | | | | | |
|---|---|---|---|---|---|---|---|
| | | Area | Area | Constant | | | |
| Specimen | | increasing | decreasing | area | Yield of | Electrode | |
| No. | S1/S2 | section | section | section | molding | temperature | Durability |
| 1 | 1.5 | Provided | None | None | 100% | 230° C. | OK |
| 2 | 1.2 | Provided | None | None | 100% | 240° C. | OK |
| 3 | 1.1 | Provided | None | None | 100% | 265° C. | OK |
| 4 | 1.2 | Provided | Provided | None | 100% | 260° C. | OK |
| 5 | 1.2 | Provided | None | Provided | 100% | 245° C. | OK |
| 6 | 1.2 | Provided | Provided | Provided | 100% | 250° C. | OK |
| 7 | 1.0 | None | None | Provided | 65% | 360° C. | NG |
| 8 | 0.8 | None | Provided | None | 40% | 430° C. | NG |

S1 is the area of the connection part of the first electrode lead-out member with the first electrode.
S2 is the area of the connection part of the first electrode lead-out member with the first lead member.

TABLE 2

| | Second electrode lead-out member | | | | | | | | |
|---|---|---|---|---|---|---|---|---|---|
| | | Area | Area | | | | | | |
| Specimen | | increasing | decreasing | Constant | Small-diameter | Metal fitting | Yield of | Electrode | |
| No. | S3/S4 | section | section | area section | section | section | molding | temperature | Durability |
| 9 | 5.8 | Provided | Provided | None | Provided | Entire electrode | 100% | 180° C. | OK |
| | | | | | | surface | | | |
| 10 | 4.9 | Provided | Provided | None | Provided | Entire electrode | 100% | 190° C. | OK |
| | | | | | | surface | | | |
| 11 | 3.7 | Provided | Provided | None | Provided | Entire electrode | 100% | 205° C. | OK |
| | | | | | | surface | | | |
| 12 | 4.9 | Provided | Provided | None | Provided | Part of electrode | 100% | 200° C. | OK |
| | | | | | | surface | | | |
| 13 | 1.3 | Provided | None | None | None | Entire electrode | 100% | 250° C. | OK |
| | | | | | | surface | | | |
| 14 | 1.0 | None | Provided | Provided | Provided | Entire electrode | 70% | 310° C. | NG |
| | | | | | | surface | | | |
| 15 | 0.9 | None | Provided | None | Provided | Entire electrode | 50% | 370° C. | NG |
| | | | | | | surface | | | |
| 16 | 1.0 | None | None | provided | None | Entire electrode | 70% | 350° C. | NG |
| | | | | | | surface | | | |

S3 is the area of the connection part of the second electrode lead-out member with the second electrode.
S2 is the area of the connection part of the second electrode lead-out member with the second lead member.

As is apparent from Table 1 and Table 2, specimens Nos. 7, 8 and 14 to 16 with no area increasing section showed low yield of molding in a range from 40% to 70%.

### BRIEF DESCRIPTION OF THE DRAWINGS

FIG. 1 is a longitudinal sectional view showing a ceramic heater according to one embodiment of the present invention.

FIG. 2 is an enlarged plan view of the vicinity of the first electrode of the ceramic heater shown in FIG. 1 as viewed in the direction of a dash line V.

FIG. 3 is an enlarged sectional view of the vicinity of the first electrode lead-out member shown in FIG. 1.

FIG. 4 is an enlarged sectional view showing another embodiment of the vicinity of the first electrode of the ceramic heater.

FIG. 5 is an enlarged sectional view showing still another embodiment of the vicinity of the first electrode of the ceramic heater.

FIG. 6 is an enlarged sectional view of the vicinity of the second electrode lead-out member of the ceramic heater shown in FIG. 1.

FIG. 7 is a front view of the ceramic heater shown in FIG. 1 as viewed in the direction H indicated with arrow in FIG. 1.

FIG. 8 is a sectional view taken along lines A-A in FIG. 1.

FIG. 9 which is an enlarged sectional view of the vicinity of the second electrode lead-out member of the ceramic heater of another embodiment.

FIG. 10 is a side view depicting a state of a metal fitting section fitted onto the second end portion of the ceramic heater shown in FIG. 1.

FIG. 11 which is a side view depicting another embodiment of the connection part structure between the second end portion and the metal fitting section.

FIG. 12 is a sectional view of a glow plug according to one embodiment of the present invention

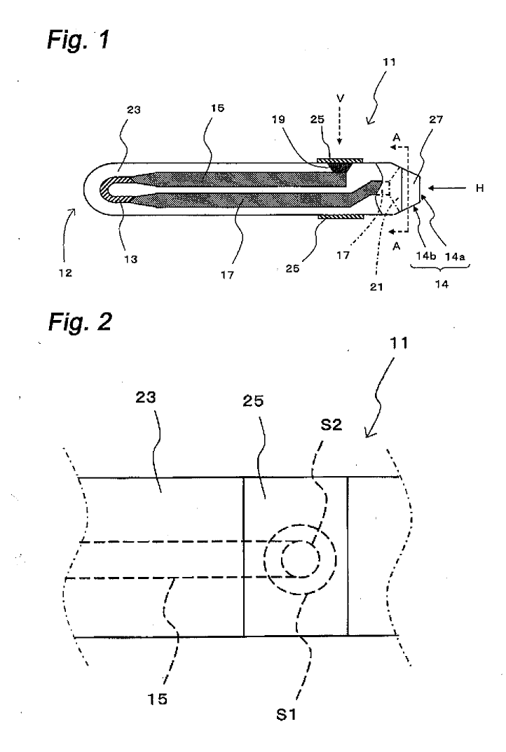

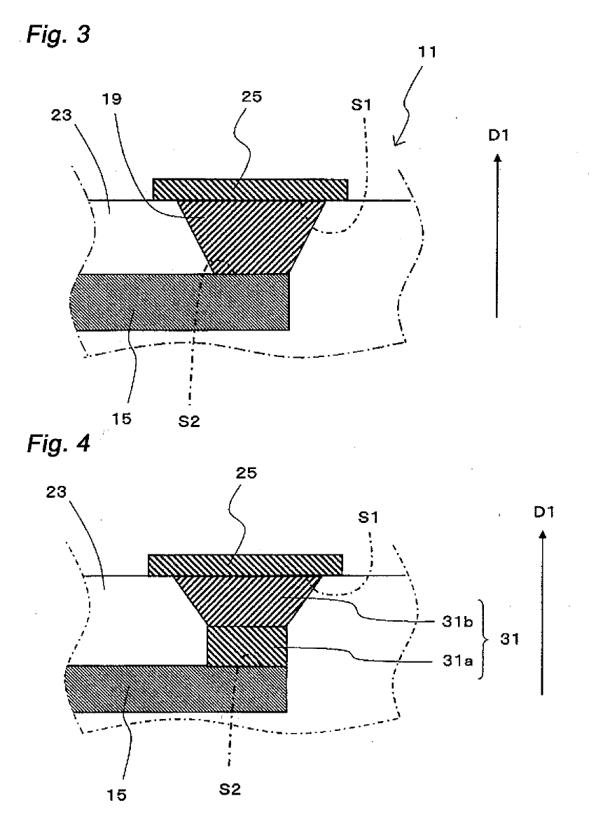

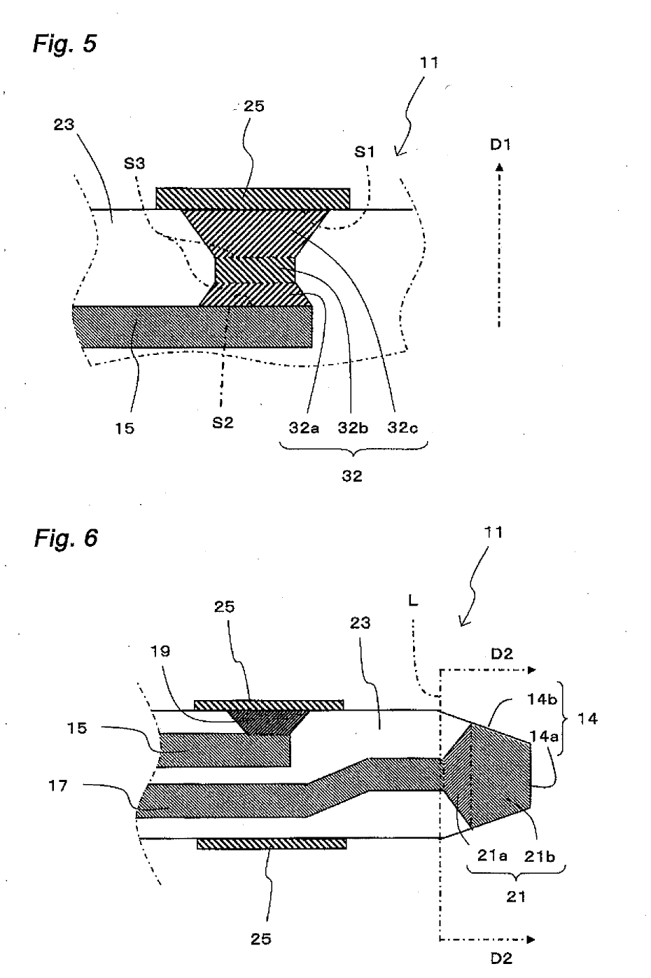

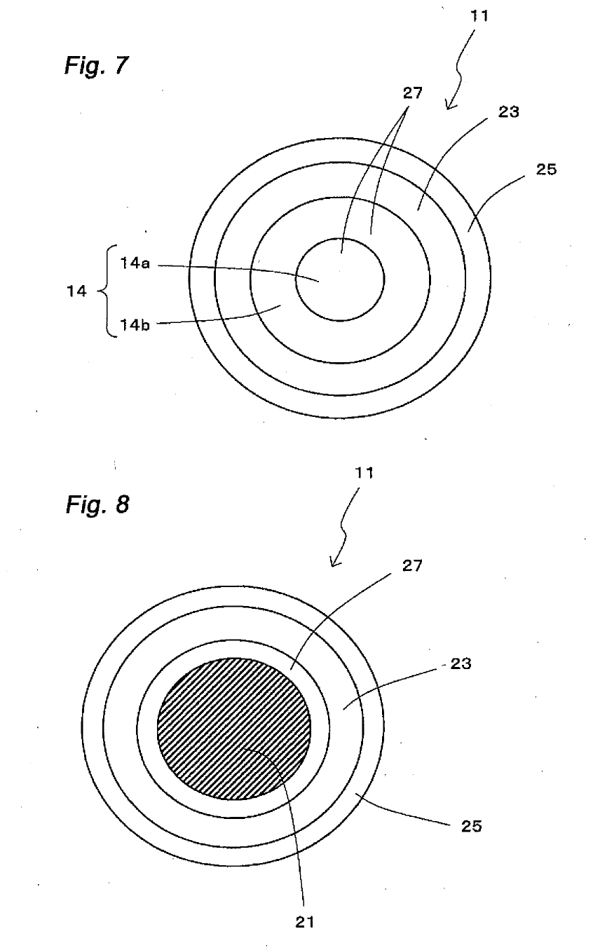

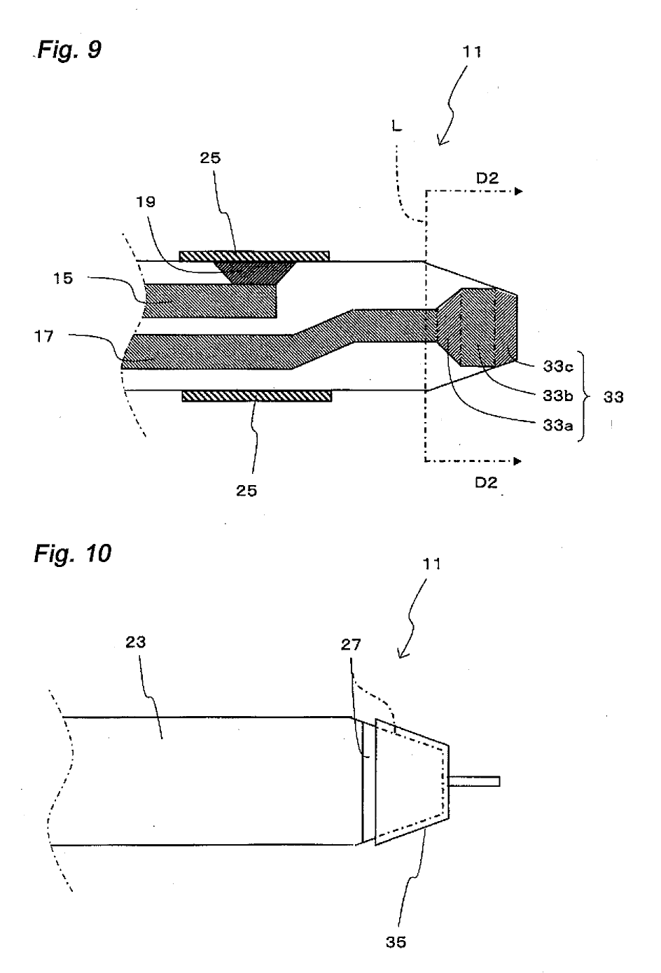

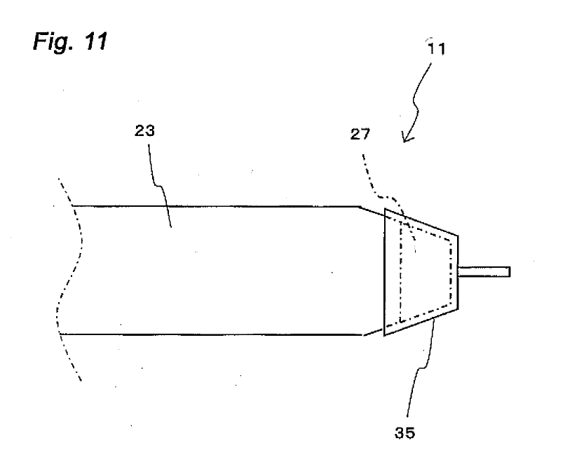

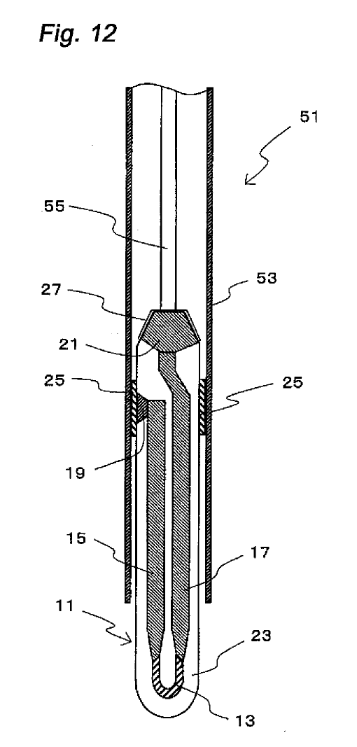

### DESCRIPTION OF REFERENCE NUMERALS

11: Ceramic heater
12: First end
13: Heating resistor
14: Second end portion (Small-diameter section)
14a: End face
14b: Lateral face
15: First lead member
17: Second lead member
19, 31: First electrode lead-out member
21, 33: Second electrode lead-out member
21a, 31b, 32c, 33a: Area increasing section
21b, 32a, 33c: Area decreasing section
23: Ceramic substrate
25: First electrode
27, 33: Second electrode
31a, 32b, 33b: Constant area section
35, 37: Metal fitting section
51: Glow plug

1-15. (canceled)

16. A ceramic heater, comprising:
a heating resistor;
a first lead member and a second lead member electrically connected to both ends of the heating resistor, respectively;
a first electrode lead-out member and a second electrode lead-out member electrically connected to an end of the first lead member and an end of the second lead member, respectively, the end of the first lead member and the end of the second lead member being opposite to the respective ends thereof that are electrically connected to the heating resistor;
a ceramic base in which the heating resistor, the first lead member, the second lead member, the first electrode lead-out member and the second electrode lead-out member are embedded; and
a first electrode and a second electrode that are formed on the surface of the ceramic base, and are electrically connected to the first electrode lead-out member and the second electrode lead-out member, respectively,
wherein an area of a connection part between the first electrode lead-out member and the first electrode is larger than an area of a connection part between the first electrode lead-out member and the first lead member.

17. The ceramic heater according to claim 16, wherein the first electrode lead-out member comprises a cross section which is perpendicular to a direction from a side of the first lead member toward a side of the first electrode and is round or oval.

18. The ceramic heater according to claim 17, wherein the first electrode lead-out member comprises an area increasing section in which an area of a cross section perpendicular to the direction increases from the side of the first lead member toward the side of the first electrode.

19. The ceramic heater according to claim 18, wherein the first electrode lead-out member comprises an area decreasing section in which an area of a cross section perpendicular to the direction decreases from the side of the first lead member toward the side of the first electrode, or an area constant section in which an area of a cross section perpendicular to the direction remains constant in the direction.

20. The ceramic heater according to claim 16, wherein
the ceramic base has a bar-shape,
the heating resistor is embedded on the first end side of the ceramic base,
the first electrode is formed on a lateral face of the ceramic base,
the second electrode is formed on an end face of a second end portion of the ceramic base, and
an area of a connection part between the second electrode lead-out member and the second electrode is larger than an area of a connection part between the second electrode lead-out member and the second lead member.

21. The ceramic heater according to claim 20, wherein the second electrode lead-out member comprises a cross section which is perpendicular to a direction from a side of the second lead member toward a side of the second electrode and is round or oval.

22. The ceramic heater according to claim 21, wherein the second electrode lead-out member comprises an area increasing section in which an area of a cross section perpendicular to the direction increases from the side of the second lead member toward the side of the second electrode.

23. The ceramic heater according to claim 22, wherein the second electrode lead-out member comprises an area decreasing section in which an area of a cross section perpendicular to the direction decreases from the side of the second lead member toward the side of the second electrode, or an area constant section in which an area of a cross section perpendicular to the direction remains constant in the direction.

24. The ceramic heater according to claim 22, wherein
the second end portion comprises a small-diameter section in which a diameter thereof becomes smaller toward an end face of the second end portion, and
the area increasing section of the second electrode lead-out member is embedded in the small-diameter section.

25. The ceramic heater according to claim 23, wherein
the second end portion comprises a small-diameter section in which a diameter thereof becomes smaller toward an end face of the second end portion,
the second electrode lead-out member comprises an area decreasing section in which an area of a cross section perpendicular to the direction decreases from the side of the second lead member toward the side of the second electrode, and
the area decreasing section is embedded in the small-diameter section.

26. The ceramic heater according to claim 25, wherein the area increasing section and the area decreasing section of the second electrode lead-out member are disposed in order from the side of the second lead member toward the side of the second electrode.

27. The ceramic heater according to claim 25, wherein
the second end portion comprises a small-diameter section in which a diameter thereof becomes smaller toward an end face of the second end portion, and
the area decreasing section is disposed along the small-diameter section.

28. The ceramic heater according to claim 20, wherein
the second electrode is formed on the end face of the second end portion and at least a portion of a lateral face of the second end portion connected to the end face, and
the second electrode is covered with a metal fitting member comprising a recess.

29. The ceramic heater according to claim 28, wherein an entire surface of the second electrode is covered with the metal fitting member.

30. A glow plug, comprising:
the ceramic heater according to claim 16.
